(19) United States
(12) Patent Application Publication
(10) Pub. No.: US 2020/0284594 A1
(43) Pub. Date: Sep. 10, 2020

(54) VEHICLE AND NAVIGATION SYSTEM

(71) Applicant: Ford Global Technologies, LLC, Dearborn, MI (US)

(72) Inventors: Bo WANG, Dearborn, MI (US); Yimin LIU, Ann Arbor, MI (US); Ambrose WONG, Melvindale, MI (US); Perry Robinson MACNEILLE, Lathrup Village, MI (US)

(21) Appl. No.: 16/650,019

(22) PCT Filed: Oct. 3, 2017
(86) PCT No.: PCT/US2017/054877

§ 371 Date: Mar. 24, 2020

(51) Int. Cl. G01C 21/34; G01C 21/36

(52) U.S. Cl. CPC G01C 21/3407; G01C 21/3691; G01C 21/3626

(57) ABSTRACT

A vehicle includes a navigation system that is programmed to, in response to selection of a destination, generate a travel route to the destination and display a total estimated travel time to the destination based on estimated travel times through intersections on the travel route and estimated travel times through road segments between intersections.

### TECHNICAL FIELD

The present disclosure relates to vehicles and navigation systems for vehicles.

### BACKGROUND

Vehicles may include navigation systems that are configured to provide travel routes between a current location of the vehicle and a selected destination.

### SUMMARY

A vehicle includes a navigation system that is programmed to, in response to selection of a destination, generate a travel route to the destination and display a total estimated travel time to the destination based on estimated travel times through intersections on the travel route and estimated travel times through road segments between intersections.

A vehicle includes a navigation system that is programmed to, in response to a generated travel route, display an estimated travel time range to an endpoint of the travel route based on a statistical distribution of estimated travel times through intersections on the travel route and estimated travel times through road segments between intersections.

A vehicle navigation system is programmed to generate a travel route from a current location to a selected destination and display a total estimated travel time to the destination based on estimated travel times through intersections on the travel route and estimated travel times through road segments between intersections. The travel times through intersections are based on real-time data and the travel times through road segments are based on real-time and historical data.

### BRIEF DESCRIPTION OF THE DRAWINGS

FIG. 1 is a schematic illustration of an exemplary vehicle having a navigation system;

FIG. 2 is a schematic illustration of a travel route from a current location to a selected destination; and

FIG. 3 is a graph illustrating a cumulative distribution of estimated travel times to reach a selected destination on a travel route.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

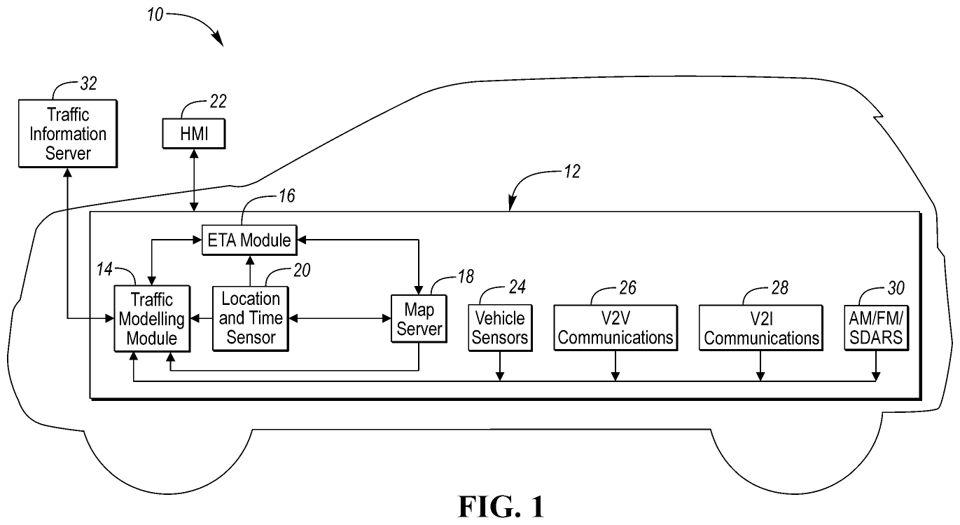

Referring to FIG. 1, an exemplary vehicle 10 having a navigation system 12 is illustrated. The navigation system 12 includes a traffic modeling module 14 that electronically communicates with an estimated time of arrival (ETA) module 16. The navigation system 12 is programmed to generate a travel route to one or more selected destinations based on a current location and the selected destination of the vehicle 10. The travel route may be generated based on any method known in the art, including but not limited to, Dijkstra's algorithm, contraction hierarchies, and the Raptor Algorithm. The ETA module 16 transmits the travel route to the traffic modeling module 14. The traffic modeling module 14 is programmed to include a traffic speed function that estimates travel speeds along the travel route. The traffic modeling module 14 is programmed to transmit the estimated travel speeds along the travel route to the ETA module 16. The traffic speed function along the travel route may be based on the time of day and the position on the travel route, and then expressed as a statistical distribution, such as a power or beta distribution.

A map server 18 is programmed to generate and transmit a mathematical representation of a road map to both the traffic modeling module 14 and the ETA module 16. A current location and time sensor 20 generates and transmits the current location of the vehicle 10 and the current time of day to the traffic modeling module 14, the ETA module 16, and the map server 18. The current location and time sensor 20 may include a digital clock and global positioning system (GPS). The navigation system 12 (or subcomponent thereof, such as the ETA module 16) may generate a travel route along a road map, provided by the map server 18, based on the current location of the vehicle 10, a selected destination of the vehicle 10 (the selected destination may also be referred to as the endpoint of the travel route), and the traffic speed function along the travel route that is generated by the traffic modeling module 14.

The navigation system 12 (including subcomponents such as the ETA module 16, traffic modeling module 14, and map server 18), may be part of a larger control system and may be in communication with or controlled by various other controllers throughout the vehicle 10, such as a vehicle system controller (VSC). The navigation system 12 may include a microprocessor or central processing unit (CPU) in communication with various types of computer readable storage devices or media. Computer readable storage devices or media may be configured to store the various functions or algorithms carried out by the navigation system, including volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the navigation system 12.

A vehicle operator may select the destination of the vehicle 10 through a human machine interface (HMI) 22. The HMI 22 may be an integral part of the navigation system 12 or maybe a separate component that communicates with the navigation system 12. The vehicle operator may select the destination of the vehicle by inputting an address into the HMI 22 or by selecting the position on a map that is displayed by the HMI 22. The HMI 22 may then display a map, the current location of the vehicle 10 on the map, a travel route from the current location of the vehicle 10 to the destination, and the estimated time of arrival of the vehicle 10 at the destination.

The traffic modeling module 14 may utilize real-time data and/or historical data to estimate the traffic speed on the travel route via the traffic speed function. The ETA module 16 may then compare the estimated traffic speed along travel route to the remaining distance on the travel route to determine the estimated time of arrival to the destination on the travel route. The estimated time of arrival from the current location to the destination on the travel route may be calculated by dividing the remaining distance on the travel route into smaller road segments and intersections, estimating the travel time on each road segment by comparing the distance of the road segment to the estimated speed on each road segment, estimating the travel time through each intersection (which may be an expected waiting time or delay at each intersection), and then determining the sum of the estimating travel times through each road segment and intersection on the travel route.

The vehicle 10 may also be configured to collect real-time data such as vehicle speed, the speed limit of the road, and the distance to other vehicles, which may be included in the traffic model when determining the estimated time of arrival. The real-time data may be transmitted from sensors 24 of the vehicle 10 to the traffic modeling module 14 to estimate the traffic speed on the travel route. The vehicles sensors 24 may be configured to determine a vehicle speed, a gas pedal position, a brake pedal position, the distance or travel time between vehicles (i.e., vehicle headway), vehicle GPS location, weather conditions (e.g., temperature, humidity, rain, snow, or any factors that may affect traffic speed, road pavement conditions, etc.), crowdsourcing data, and social media data. The real-time data from the vehicle sensors 24 may be utilized by the traffic modeling module 14 alone or in conjunction with any other type of data mentioned herein to estimate the traffic speed through any portion or road segment of the travel route. The real-time data from the vehicle sensors 24 may be accurate for estimating the traffic speed at the current vehicle location. However, the accuracy of estimating the traffic speed may decrease when real-time data from vehicle sensors is utilized to estimate traffic speed at locations on the travel route other than the current location. Therefore, the real-time data from the vehicle sensors 24 may be weighted so that it has an increased affect in estimating travel times through portions or segments of the travel route that are closer to the current location and a decreased affect in estimating travel times through portions or segments of the travel route that are further away from the current location. The real-time data from the vehicle sensors 24 may be weighted based on the distance data relative to other vehicles in the front of and/or behind the vehicle 10, and the speed limit of the road.

Real-time weather data may be transmitted from the sensors 24 of the vehicle 10 to the traffic modeling module 14. The vehicle 10 may collect weather information (e.g., rain, fog, or snow) from the immediate vicinity via the sensors 24 to estimate the impacts on travel speed or potential waiting times at specific locations, such as an intersection. Predicted vehicle speeds under specific weather conditions may be based on historical speed data collected during similar weather conditions.

Real-time data collected from social media, may include posted complaints of traffic congestion, traffic signal outages, accidents, or other related issues. The real-time data collected from social media may also be utilized by the traffic modeling module 14 when determining estimate travel time.

Real-time data may also be transmitted by wireless communication to the traffic modeling module 14 to estimate the traffic speed on the travel route. Real time data transmitted by wireless communication to the traffic modeling module 14 may include vehicle-to-vehicle communication 26 (i.e., data transmitted and received from other vehicles), vehicle-to-infrastructure communication (i.e., data transmitted and received from the roadway infrastructure) 28, radio transmissions (e.g., AM, FM, or Satellite digital audio radio service) 30, and/or a traffic information server 32.

The real-time data from vehicle-to-vehicle communication 26 may include an exchange of sensor information from other vehicles. The sensor information of other vehicles may include a vehicle speed, a gas pedal position, a brake pedal position, the distance or travel time between vehicles (i.e., vehicle headway), vehicle GPS location, and weather conditions (e.g., temperature, humidity, rain, snow, or any factors that may affect traffic speed, road pavement conditions, etc.) of the other vehicles. The data received from other vehicles may include real-time data from locations on the travel route other than the current location of vehicle 10. Therefore, the real-time data from vehicle-to-vehicle communication 26 may be more accurate than data from the sensors 24 of the vehicle 10 when utilized to estimate the traffic speed through portions or segments of the travel route other than the current location of the vehicle 10. The real-time data from vehicle-to-vehicle communication 26, however, may be utilized by the traffic modeling module 14 alone or in conjunction with other any other type of data mentioned herein to estimate the traffic speed through any portion or road segment of the travel route, including the current location of the vehicle 10, as long other vehicles are transmitting real-time data from the particular portion or road segment of the travel route to the vehicle 10.

The real-time data from vehicle-to-vehicle communication 26 may also include probabilistically weighted route lists. The algorithm in the traffic modeling module 14 may utilize the route list information to anticipate the routes that other vehicles may be travelling on to adjust the estimated time of arrival calculation. Vehicle-to-vehicle communication 26 may also include communicating various vehicle characteristics such the dimensions, articulation features, power vs. mass, and braking characteristics other vehicles. Data from vehicle-to-vehicle communication 26 may also include information about the psycho-physical driver model parameters, the adaptive cruise control parameters, the cooperative adaptive cruise control parameters, etc.

The real-time data from vehicle-to-infrastructure communication 28 may include communications from roadside devices (e.g., traffic signals), wireless communication towers (e.g., cellular towers), satellites, a traffic control system or center, etc. The data received via vehicle-to-infrastructure communication 28 may include traffic volume (i.e., the quantity of vehicles operating in a geographical area, which may be estimated by observing the rate at which vehicles enter and/or a leave a geographical area), traffic signal timing, pavement conditions, work zone conditions, roadway incidents, traffic flow rates (vehicles/minute), velocity (average miles/hour), and vehicle density (vehicles/mile). The type of vehicle flow may be characterized (e.g., in a 3-phase system that includes jammed, synchronous flow, or free flowing). The real-time data from vehicle-to-infrastructure communication 28 may be utilized by the traffic modeling module 14 alone or in conjunction with any other type of data mentioned herein to estimate the traffic speed through any portion or road segment of the travel route and/or intersection of the travel route.

Traffic signal timing data and traffic backup data at an intersection (i.e., the number of cycles of the traffic signal a vehicle has to wait before passing through particular intersection or a typical waiting time if the intersection includes a stop or yield sign) may be utilized in conjunction with estimated times of arrival at a particular intersection on the travel route to estimate the travel time through a particular intersection. For example, if the estimated time of arrival at a particular intersection coincides with a traffic signal light at the intersection being red, the travel time through the intersection will be longer than if the estimated time of arrival at the particular intersection happened to coincide with the traffic signal light being green. The number of cycles of the traffic signal a vehicle has to wait before passing through particular intersection may be referred to as the dwell time of the intersection and may be based on the degree of saturation of the intersection. The delay caused by a traffic signal may be referred to as the control delay. The equation for calculating the control delay comprises three elements: uniform delay, incremental delay, and initial queue delay. The primary factors that affect control delay are lane group volume, lane group capacity, cycle length, and effective green time. Factors are provided that account for various conditions and elements, including signal controller type, upstream metering, and delay and queue effects from oversaturated conditions. The infrastructure may report the uniform delay, incremental delay and initial queue delay, lane group volume, lane group capacity, cycle length, effective green time, delay and queue effects due to oversaturation of the intersection.

The real-time data from radio transmissions may include communication regarding traffic accidents at a particular location, lane closures, traffic signal outages, and other traffic incidents. The real-time data from radio transmission may be utilized by the traffic modeling module 14 alone or in conjunction with any other type of data mentioned herein to estimate the traffic speed through any portion or road segment of the travel route and/or intersection of the travel route.

The real-time data from the traffic information server 32 may include data regarding traffic districts (i.e., a geographical area) that are adjacent to or located along the travel route of the vehicle 10. The real-time data may include traffic signal timing data within the district, planned special events occurring within the district (sporting events, concerts, etc.), construction within the district, traffic accidents within the district, and the traffic volume within the district. The traffic volume within the district may be based on flow rates of vehicles into and out of the district at predetermined points along the boundary of the district or flow rates of vehicles into and out of parking facilities within the district. The flow rates may be determined by infrastructure devices, such as cameras, that observe traffic flow. The traffic modeling module 14 may utilize the data from a specific traffic district, reducing the computational load by limiting the geographical extent of the model. At the boundary between districts simplified data may be provided only for the connectors between districts. The infrastructure may also include information about vehicle storage (such as within parking lots) and the rate of exchange between storage structures and locations within the traffic district.

The historical data that may be used to estimate the traffic speed on the travel route may include data of previously recorded traffic speeds along the travel route. The historical data may be filtered based on the time of day, day of the week, specific location on the route, etc. The historical data may be stored on a data file system located on the vehicle 10 or may be located remotely and transmitted to the vehicle 10 via wireless communication, for example, from the traffic information server 32. The historical data for a district may be very large compared to the available storage on the vehicle, and therefore may be stored as data objects in a virtual distributed data file system (such as a Hadoop Distributed File System) where the physical storage spans the vehicle storage devices and infrastructure storage devices that communicate with the vehicle via vehicle-to-infrastructure communication 28. Analytical processes may be applied to the data by processors in the infrastructure to reduce the amount of communication and processing that must be done locally in the vehicle. By distributing the storage and processing, and with spatial decomposition of the traffic modeling using traffic districts, it is possible to make the storage and processing efficient and scalable. The historical data may include previously recorded data from any of the sources mentioned above. For example, the historical data may include any previously recorded data from the sensors 24 of the vehicle 10, vehicle-to-vehicle communication 26, vehicle-to-infrastructure communication 28, radio transmissions 30, or the traffic information server 32.

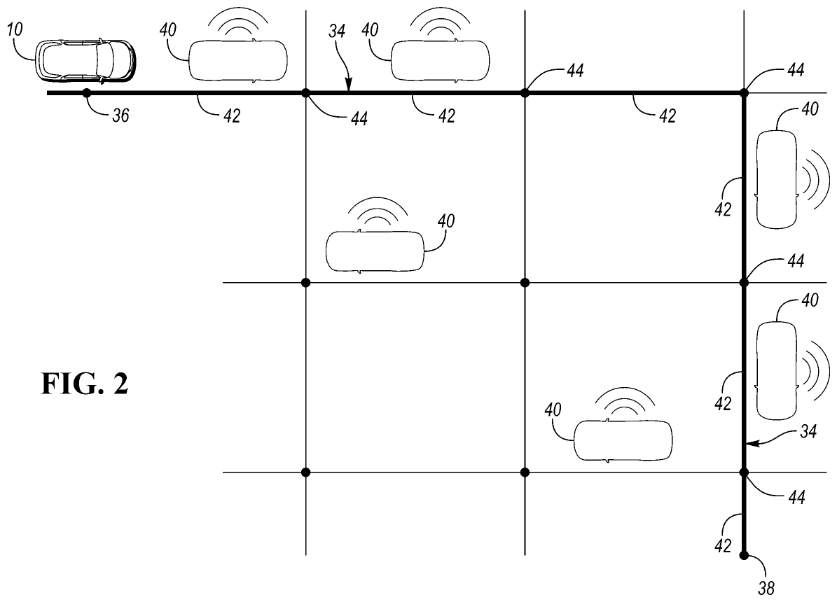

Referring to FIG. 2, a generated travel route 34 of the vehicle 10 from a current location 36 to a selected destination 38 is illustrated. Other vehicles 40 traveling on the travel route 34 that are configured to transmit traffic speed data to the vehicle 10 are also illustrated. The travel route 34 is divided into road segments 42 and intersections 44. The travel time through each road segment 42 may be based on the traffic speed estimate through the particular road segment 42 determined by traffic modeling module 14 and the length of the particular road segment 42. The length of a road segment may be a distance between intersections 44 on opposing sides of the particular road segment 42, a distance between a current position of the vehicle 10 and the next intersection 44, a distance between an intersection 44 and the selected destination 38 (if the intersection is last intersection before the selected destination), or a distance between a current position of the vehicle 10 and the selected destination 38 (if the selected destination 38 is located on the particular road segment 42 the vehicle 10 is currently traveling on). The travel time through each intersection 44 may be based an expected waiting time or delay at each intersection. The total travel time through the travel route 34 may be the summation of the travel times through all of the segments 42 and intersections 44 on the travel route 34 and may be represented by equation (1):

ETAₜₒₜₐₗ=Σᵢ₌₁ⁿETAᵣₛ+Σⱼ₌₁^{k}ETAᵢₙₜ (1)

where ETAₜₒₜₐₗ is the total estimated travel time on the generated travel route 34, ETAᵣₛ is the estimated travel time through individual road segments 42 on the travel route 34, and ETAᵢₙₜ is the estimated travel time through individual intersections 44 on the travel route 34.

It should be noted that the variables for determining the estimated time of arrival are not necessarily independent random variables. The ETAₜₒₜₐₗ to reach the selected destination 38 (or to reach each stop along the travel route 34 if there are multiple stops) may be expressed as a cumulative distribution function. Loading and unloading delays may also be estimated and considered when calculating the estimated time of arrival. The vehicle sensors 24 may be utilized to determine how many people are in the vehicle and where they are located. A reservation system can determine how many people are waiting to get on the shuttle at a stop. These inputs can be utilized to determine a random variable representing the time needed at a stop.

The type of data that is utilized to determine the travel times through each road segment 42 and intersection 44 on the travel route 34 may include any type of the real-time data, historical data, or any combination thereof. Some data may be weighted so that it has an increased affect in estimating travel times through a particular road segment 42 or intersection 44 on the travel route 34. For Example, the real-time traffic speed data transmitted from other vehicles 40, when available, on a particular road segment 42 may be weighted heavier than historical data, or the real-time data may be the only data considered, when estimating the travel time through the particular segment 42. Another example may include estimating the travel time through the particular segment 42 using historical data alone, if real-time traffic speed data transmitted from other vehicles 40 is not available.

The estimated travel time to the destination 38 or to reach each stop along the travel route 34 if there are multiple stops) on the travel route 34 may be based on a statistical distribution of the data, which may be any of the real-time data, historical data, or combination thereof. The statistical distribution may be any type of statistical distribution including, but not limited to, a normal distribution, a beta distribution, etc. The estimated travel time my then be represented by a random variable with defined distribution functions such as a power distribution function and/or a cumulative distribution function. The statistical distribution may be used to calculate probable traffic speeds through each road segment 42 (which is then used along with a distance to be traveled on the road segments 42 to calculate a probable travel time through each road segment 42) and the probable waiting time or delay at each intersection 44. The probable travel time through each road segment 42 and the probable waiting time or delay at each intersection 44 may then be input into the total travel time equation (1) above to determine a probable expected arrival time at the destination 38 (or endpoint on the travel route).

The traffic speed function or model calculated or estimated in the traffic modeling module 14 may be a micro-simulation, macro-simulation, neural net, cellular automata, etc. The traffic speed function may predict the traffic speed at a space-time location (t,s) on the travel route 34. The traffic speed function may obtain an actual measurement when the space-time location (t,s) on the travel route 34 is reached. The actual measurement may be used to tune the traffic speed function or model in collaboration with data from vehicle-to-vehicle communication to improve the accuracy. When represented as a beta statistical distribution, the traffic modeling module 14 may provide the estimated traffic speed function or model as a set of parameters to the function (α, β)= [symbol] (t,s,n̅) where t is a time in the future, s is the distance from the beginning of the segment, n̅ is the particular road segment, and (α, β) are parameters to a beta distribution function. The probability (P_{ν}) the traffic is moving at a particular speed (ν) at a particular position or road segment 42 along the travel route 34 may be determined by equations (2) and (3):

$$\begin{matrix}{P}_{v} = \frac{{v}^{α - 1} 1 - {v}^{β - 1}}{B ( α , β )} & ( 2 ) \\ B ( α , β ) = \frac{Γ ( α ) Γ ( β )}{Γ ( α + β )} & ( 3 )\end{matrix}$$

where Γ is the Gamma Function.

Other statistical values such as mean speed

$$( μ = \frac{α}{α + β} ) ,$$

variance

$$( var = \frac{αβ}{{( α + β )}^{2} ( α + β + 1 )} ) ,$$

cumulative distribution function, median, mode, skewness, kurtosis, entropy, etc., may be calculated using the beta distribution. The probability (P_{ν}) the traffic is moving at a particular speed (ν) may then be used calculate estimated or probable travel times through individual road segments 42 and intersections 44, which then may be used to calculate the estimated or probable total travel time on the travel route 34 to reach the destination 38.

It should be noted that when the vehicle 10 enters the travel route 34 it may have little knowledge of the actual local traffic information. Under such a circumstance, the vehicle 10 may rely entirely on data from the traffic information server, whether it be historical or real-time to determine the estimated time of arrival. As it moves through the travel route 34 additional current information is collected and the n̅ vector be change, moving expected values, reducing variance, etc. consistent with a more accurate estimated time of arrival at the destination 38 based on more up-to-date information. Another note is that (t,s) points on the path are correlated in different amounts, depending how close they are to the current location of the vehicle 10 on the travel route 34. The relationship between the ratio of s and t has a tendency to remain constant through highly correlated sections of the route because the traffic conditions do not change significantly.

The beta distribution may also be utilized to calculate the traffic volume within a geographical district. The αs and βs are specific parameters for rates at which vehicles enter and exit a traffic district, or a parking facility within the traffic district, at particular time based on observing traffic flow rates with infrastructure devices. α and β value may be determined between particular observed times by extrapolation.

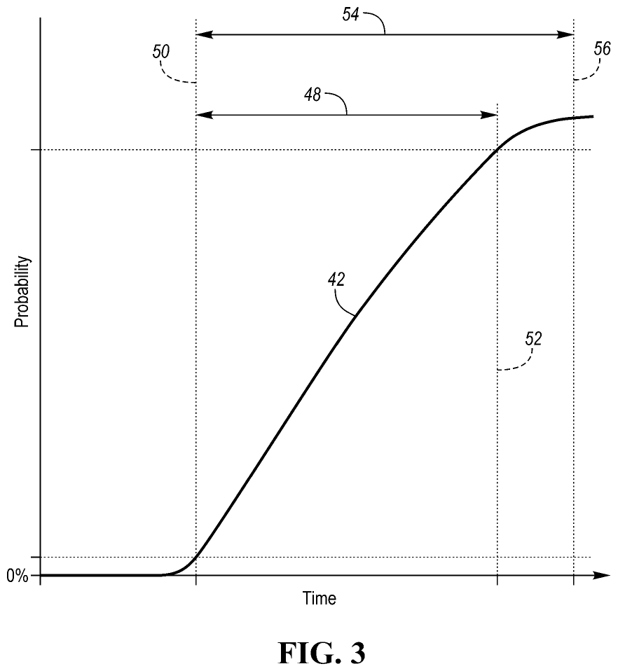

Referring to FIG. 3, a graph representing the cumulative distribution function 46 of probable estimated travel times to reach the selected destination 38 on the travel route 34 is illustrated. The horizontal axis includes a set of estimated arrival times at the destination 38 based on the statistical distribution. The vertical axis includes the probability (which may be represented as percentage) of reaching the destination 38 by the estimated arrival times. As the time increases on the horizontal axis, the probability of having reached the selected destination 38 increases. The cumulative distribution function 46 may include a first time window 48, which may represent a range of expected estimated times of arrival for reaching the destination 38. The first time window 48 may extend from a first probable estimated time of arrival 50 to a second probable estimated time of arrival 52. The first probable estimated time of arrival 50 may correspond to an earliest probable estimated time of arrival. The cumulative distribution function 46 may include a second time window 54, which may represent a range of guaranteed estimated times of arrival for reaching the destination 38. The second time window may extend from the first probable estimated time of arrival 52 a third probable estimated time of arrival 56. The third probable estimated time of arrival 56 may correspond to a latest probable estimated time of arrival. The third probable estimated time of arrival 56 is later than the second probable estimated time of arrival 52. The HMI 22 may be configured to display the estimated time of arrival according to the statistical distribution such that the first time window 48 is displayed, the second time window 54 is displayed, or the first probable estimated time of arrival 50 is displayed along with the second probable estimated time of arrival 52 and/or the third probable estimated time of arrival 56.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A vehicle comprising:
a navigation system programmed to, in response to selection of a destination, generate a travel route to the destination and display a total estimated travel time to the destination based on estimated travel times through intersections on the travel route and estimated travel times through road segments between intersections.

2. The vehicle of claim 1, wherein the estimated travel time through each road segment is based on a predicted vehicle speed through each segment.

3. The vehicle of claim 2, wherein the navigation system is further programmed to receive real-time traffic speed data of a first of the road segments transmitted from other vehicles and the predicted vehicle speed through the first of the road segments is based on the real-time speed data.

4. The vehicle of claim 3, wherein the navigation system is further programmed to receive historical traffic speed data of the first of the road segments and the predicted vehicle speed through the first of the road segments is based on the historical traffic speed data and the real-time speed data.

5. The vehicle of claim 2, wherein the predicted vehicle speed through a first of the road segments is based only on historical traffic speed data of the first of the road segments and a distance between the intersections associated with the road segment.

6. The vehicle of claim 1, wherein the navigation system is further programmed to receive real-time data transmitted from a traffic control system and the estimated travel time through each intersection is based on the real-time data.

7. The vehicle of claim 6, wherein the real-time data includes traffic signal timing data.

8. The vehicle of claim 6, wherein the real-time data includes a rate at which vehicles enter a predetermined geographical area.

9. A vehicle comprising:
a navigation system programmed to, in response to a generated travel route, display an estimated travel time range to an endpoint of the travel route based on a statistical distribution of estimated travel times through intersections on the travel route and estimated travel times through road segments between intersections.

10. The vehicle of claim 9, wherein the estimated travel time through each road segment is based on a probable vehicle speed through each segment.

11. The vehicle of claim 10, wherein the navigation system is further programmed to receive real-time traffic speed data of a first of the road segments transmitted from other vehicles and the probable vehicle speed through the first of the road segments is based on a beta distribution of data that includes the real-time traffic speed data.

12. The vehicle of claim 11, wherein the navigation system is further programmed to receive historical traffic speed data of the first of the road segments and the probable vehicle speed through the first of the road segments is based on a beta distribution of data that includes the real-time traffic speed data and the historical traffic speed data.

13. The vehicle of claim 9, wherein the navigation system is further programmed to receive real-time data transmitted from a traffic control system and the estimated travel time through each intersection is based on the real-time data.

14. The vehicle of claim 13, wherein the real-time data includes traffic signal timing data.

15. The vehicle of claim 13, wherein the real-time data includes a rate at which vehicles enter a predetermined geographical area.

16. The vehicle of claim 9, wherein travel time range includes a first expected arrival time at the endpoint and a second expected arrival time at the endpoint that is later expected arrival time.

17. A vehicle navigation system programmed to:
generate a travel route from a current location to a selected destination; and
display a total estimated travel time to the destination based on estimated travel times through intersections on the travel route and estimated travel times through road segments between intersections, wherein the travel times through intersections are based on real-time data and the travel times through road segments are based on real-time and historical data.

18. The system of claim 17, wherein the real-time data includes real-time traffic speed data of a first of the road segments transmitted from other vehicles.

19. The system of claim 18, wherein the historical data includes historical traffic speed data of the first of the road segments.

20. The system of claim 19, where the real-time data includes estimated travel time through each intersection transmitted from a traffic control system.
